(19) United States
(12) Patent Application Publication
(10) Pub. No.: US 2008/0175955 A1
(43) Pub. Date: Jul. 24, 2008

(54) Composition and method of stabilized sensitive ingredient

(76) Inventors: Monika Barbara Horgan, Oxford, OH (US); Julie D. Grefer, Centerville, OH (US); Dean Larry DuVal, Lebanon, OH (US); Stephen Robert Glassmeyer, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 12/009,370

(22) Filed: Jan. 18, 2008

Related U.S. Application Data
(60) Provisional application No. 60/881,222, filed on Jan. 19, 2007.

(51) Int. Cl. A23L 1/303; A23L 1/302; A21D 2/00; A23L 1/305; A23L 1/304

(52) U.S. Cl. 426/61; 426/503; 426/89; 426/73; 426/72

(57) ABSTRACT

The present invention relates to a process of forming a coated sphere comprising the steps: (a) combining an alkali metal alginate with water; (b) preparing a mixture of said alkali metal alginate with a sensitive ingredient; (c) pumping said mixture to a nozzle; (d) cutting said mixture with a fluid stream; (e) forming a sphere; (f) dropping said sphere into an coating matrix; (g) providing a first protective coating around said sphere; and (h) forming a coated sphere.

This application claims the benefit of U.S. Provisional Application No. 60/881,222, filed Jan. 19, 2007.

### FIELD OF THE INVENTION

The present invention relates to a process of forming a coated sphere comprising the steps: (a) combining an alkali metal alginate with water; (b) preparing a mixture of said alkali metal alginate with a sensitive ingredient; (c) pumping said mixture to a nozzle; (d) cutting said mixture with a fluid stream; (e) forming a sphere; (f) dropping said sphere into an coating matrix; (g) providing a first protective coating around said sphere; and (h) forming a coated sphere.

### BACKGROUND OF THE INVENTION

Many biologically important compounds lose activity if exposed to heat, water and/or oxygen. Such compounds include vitamins, antioxidants, carotenoids, polyphenols, minerals, fatty acids, amino acids, enzymes, probiotics and prebiotics. Numerous attempts have been made in an effort to stabilize these compounds so that the activity of the compounds is maintained over longer periods of time upon exposure to heat, water and/or oxygen. Certain of these methods have focused on coating of the compounds with a protective material, including gelatin and alginate. Protecting the compounds against degradation is not the only concern, however. The protected compounds must also be available for biological absorption upon ingestion. These two purposes are inherently conflicting in that known methods of protection of the compounds during processing and storage have also limited or prevented absorption of the compounds so that less of the biologically important compound is effectively delivered to the ingesting organism.

One of the major uses of the compounds described previously is in food, including both human food and animal food. Ambient temperatures and storage conditions typically lead to a loss of activity of the compounds over time frames that are usually shorter than the other limiting times for most foods. While the use of sealed containers and low-temperature storage ameliorates the degradation of the compounds, these methods are expensive and often not practical.

Many food processing methods use heat which further reduces the level of these compounds. A particularly common food processing method is extrusion, a process that involves aggressive comminuting of the food product under extreme temperatures and pressures. Extrusion is used in the commercial production of almost all dry pet foods, and is very common in the production of ready-to-eat cereals. Addition of the compounds after extrusion leaves the compounds more susceptible to oxidation due to oxygen in the atmosphere and results in visual detection of the compound on the surface of the food product. Application of the compounds is also difficult because of product wicking from the surface of the extruded diet which results in active ingredients being transferred to the sides of the container in which the diet is stored.

The only option to be able to deliver the compounds is to over-formulate the labile components that are included in the food. This over-formulation adds unnecessary expense and does not guarantee product performance.

It is therefore an object of the present invention to provide a composition and method of stabilizing sensitive ingredients in which the sensitive ingredients in a composition are stable, the sensitive ingredients' activity is maintained in the presence of heat, water and/or oxygen, and the sensitive ingredients are still available for biological absorption upon ingestion.

### SUMMARY OF THE INVENTION

The present invention relates to a process of forming a coated sphere comprising the steps: (a) combining an alkali metal alginate with water; (b) preparing a mixture of said alkali metal alginate with a sensitive ingredient; (c) pumping said mixture to a nozzle; (d) cutting said mixture with a fluid stream; (e) forming a sphere; (f) dropping said sphere into an coating matrix; (g) providing a first protective coating around said sphere; and (h) forming a coated sphere.

The present invention further relates to a coated sphere prepared by a process comprising the steps: (a) combining an alkali metal alginate with water; (b) preparing a mixture of said alkali metal alginate with a sensitive ingredient; (c) pumping said mixture to a nozzle; (d) cutting said mixture with a fluid stream; (e) forming a sphere; (f) dropping said sphere into a coating matrix; (g) providing a first protective coating around said sphere; and (h) forming a coated sphere.

The present invention further relates to a process of forming a coated sphere comprising the steps: (a) preparing a first mixture of a hydrophobic material with a sensitive ingredient; (b) forming a second protective coating with said sensitive ingredient located within said second protective coating; (c) combining an alkali metal alginate with water; (d) preparing a second mixture by combining said alkali metal alginate with said first mixture; (e) pumping said second mixture to a nozzle; (f) cutting said second mixture with a fluid stream; (g) forming a sphere; (h) dropping said sphere into a coating matrix; (i) providing a first protective coating around said sphere; and (j) forming a coated sphere.

### BRIEF DESCRIPTION OF THE DRAWINGS

FIG. 1 is a block diagram of the overall first process of stabilizing a sensitive ingredient;

FIG. 2 is a block diagram of the mixing system of FIG. 1;

FIG. 3 is a block diagram of the sphere formation system of FIG. 1;

FIG. 4 is a block diagram of the curing system of FIG. 1;

FIG. 5 is a block diagram of the overall second process of stabilizing a sensitive ingredient;

FIG. 6 is a block diagram of the mixing system of FIG. 5;

FIG. 7 is a block diagram of the sphere formation system of FIG. 5;

FIG. 8 is a block diagram of the curing system of FIG. 5; and

FIG. 9 is a block diagram of the secondary coating system.

### DETAILED DESCRIPTION OF THE INVENTION

The present invention comprises to a process of forming a coated sphere comprising the steps: (a) combining an alkali metal alginate with water; (b) preparing a mixture of said alkali metal alginate with a sensitive ingredient; (c) pumping said mixture to a nozzle; (d) cutting said mixture with a fluid stream; (e) forming a sphere; (f) dropping said sphere into an coating matrix; (g) providing a first protective coating around said sphere; and (h) forming a coated sphere.

These and other limitations of the compositions, processes, and methods of the present invention, as well as many of the optional ingredients suitable for use herein, are described in detail hereinafter.

As used herein, the term “adapted for use” means that the pet food compositions described can meet the American Association of Feed Control Officials (AAFCO) safety requirements for providing pet food compositions for a pet as may be amended from time to time.

As used herein, the term “companion animal” means an animal preferably including (for example) dogs, cats, kitten, puppy, senior dog, senior cat, adult dog, adult cat, horses, cows, sheep, pigs, rabbits, guinea pig, hamster, gerbil, ferret, horses, zoo mammals and the like. Dogs, cats, kitten, puppy, senior dog, senior cat, adult dog, adult cat are particularly preferred.

The term “complete and nutritionally balanced” as used herein, unless otherwise specified, refers to a pet food composition having all known required nutrients in proper amounts and proportions based upon the recommendation of recognized authorities in the field of pet nutrition.

As used herein, the term “pet composition” means a composition that can be ingested by a companion animal or livestock, supplements for a companion animal, feed supplement for livestock, treats, biscuits, chews, beverages, supplemental water, and combinations thereof. The pet composition can be wet, and/or dry.

As used herein, the term “sphere” means a form that can be a segment, a rod, a three-dimensional shape, a semi-spherical shape, a semi-sphere, and/or a rounded shape.

As used herein, the term “wet” compositions means the compositions can be moist and/or semi-moist.

As used herein, the term “fluid stream”, unless otherwise specified, means a stream of air, nitrogen, carbon dioxide, argon, helium, hydrogen, and/or steam.

As used herein, the term “chemical stability” refers to the relative amount of a coated sensitive ingredient or uncoated sensitive ingredient that survives processing and/or storage compared to the amount of either ingredient that was added to the ingredient mix prior to processing of the pet composition.

As used herein, the term “bioavailability” refers to the relative amount of coated sensitive ingredient or uncoated sensitive ingredient that is absorbed through the digestive track of the animal compared to the amount of either ingredient that was ingested by the animal.

All percentages, parts and ratios as used herein are by weight of the total product, unless otherwise specified. All such weights as they pertain to listed ingredients are based on the active level and, therefore do not include solvents or by-products that may be included in commercially available materials, unless otherwise specified.

The composition, processes, and methods of the present invention can comprise, consist of, or consist essentially of, the essential elements and limitations of the invention described herein, as well as any additional or optional ingredients, components, or limitations described herein or otherwise useful in compositions intended for a companion animal or human consumption.

Composition Form

The composition of the present invention can be in the form of a pet composition and/or human composition. The composition of the present invention can comprise a base food. The composition comprises a sensitive ingredient that can be mixed with the base food during the process described herein. The composition can be a ready-to-eat food, baby food, snacks, cereals, pasta, yoghurts, puddings, desserts, treats, kibbles, pates, processed meats such as hot dogs, sausages, meatballs, and combinations thereof.

In one embodiment, the composition is in the form of wet pet composition. The wet pet compositions of the present invention can be a semi-moist pet composition (i.e. those having a total moisture content of from 16% to 50%, by weight of the composition), and/or a moist pet compositions (i.e. those having a total moisture content of greater than 50%, by weight of the composition). Unless otherwise described herein, semi-moist pet composition, and moist pet compositions are not limited by their composition or method of preparation. In another embodiment the pet composition is dry (i.e. those having a total moisture content of less than 16%, by weight of the composition).

The pet composition herein can be complete and nutritionally balanced. A complete and nutritionally balanced pet composition may be compounded to be fed as the sole ration and is capable of maintaining the life and/or promote reproduction without any additional substance being consumed, except for water.

In one embodiment, the composition is in the form of baby food composition. The baby food composition of the present invention can be a semi-moist baby food composition s (i.e. those having a total moisture content of from 16% to 50%, by weight of the composition, and/or a moist baby food composition s (i.e. those having a total moisture content of greater than 50%, by weight of the composition).

### Sensitive Ingredient

The composition of the present invention comprises a sensitive ingredient wherein the sensitive ingredient is preferably within a first and/or second protective coating. By placing the sensitive ingredient in a protective coating, the sensitive ingredient is protected against oxygen degradation not only through physical protection from contact with oxygen, but also by protecting them against interaction with oxidizing agents and free-radical initiators that may be present in the base food to which the sensitive ingredient compounds have been added to and mixed with during processing

When a sensitive ingredient is present in a composition, the sensitive ingredient of the present invention has a Chemical Stability Index of at least about 1.05, at least about 1.1, at least about 1.2, at least about 1.3, at least about 1.4, and least about 1.5, as calculated by Equation 1 below;

$$Chemical Stability Index = \frac{Chemical Stability of coated sensitive ingredient}{\begin{matrix}Chemical Stability of \\ uncoated sensitive ingredient\end{matrix}} . \qquad Equation 1$$

The Chemical Stability of a sensitive ingredient is measured by the Chemical Stability Method described hereafter.

When a sensitive ingredient is present in a composition, the sensitive ingredient of the present invention has a Bioavailability Index of at least about 1.05, at least about 1.1, at least about 1.2, at least about 1.3, at least about 1.4, and least about 1.5, calculated by Equation 2 below;

$$Bioavailability Index = \frac{Bioavailability of coated sensitive ingredient}{Bioavailability of uncoated sensitive ingredient} . \qquad Equation 2$$

The Bioavailability of a sensitive ingredient is as measured by the Bioavailability Method described hereafter.

When the sensitive ingredient has a relatively high chemical stability in an uncoated form but has relatively poor bioavailability due to degradation during the digestive process, the encapsulation process will have more of an improvement in Bioavailability Index versus Chemical Stability Index. In this type of situation, the sensitive ingredient of the present invention has a Horgan Indices of less than about 0.80, less than about 0.75, less than about 0.65, less than about 0.60, less than about 0.55, and less than about 0.45, as measured by the Horgan Equation described hereafter.

When the sensitive ingredient has a relatively low chemical stability in an uncoated form due to degradation during processing or storage, but has relatively high bioavailability, the encapsulation process will have more of an improvement in Chemical Stability Index versus Bioavailability Index. In this type of situation, the sensitive ingredient of the present invention has a Horgan Indices of greater than about 1.3, greater than about 1.4, greater than about 1.5, greater than about 1.55, greater than about 1.6, and greater than about 1.65, as measured by the Horgan Equation described hereafter.

The Horgan Index is a measure of relative improvement of either the Chemical Stability Index, as defined by Equation 1, or the Bioavailability Index, as defined by Equation 2, relative to the other Index. Specifically, the Horgan Index is calculated by Equation 3 below;

$$Horgan Index = \frac{Chemical Stability Index}{Bioavailability Index} . \qquad Equation 3$$

When a sensitive ingredient is present in a composition, the composition comprises at least about 0.01% of a sensitive ingredient on a dry matter basis, by weight of the composition. The composition comprises on a dry matter basis from about 0.1% of said sensitive ingredient to about 60% of said sensitive ingredient, from about 1% of said sensitive ingredient to about 40% of said sensitive ingredient, from about 1% of said sensitive ingredient to about 30% of said sensitive ingredient, from about 3% of said sensitive ingredient to about 20% of said sensitive ingredient, by weight of the composition.

The sensitive ingredient comprises at least one carotenoid, polyphenol, vitamin, mineral, catechin, unsaturated fatty acid, unsaturated triglyceride, antioxidant, amino acid, enzyme, prebiotic, or probiotic.

The carotenoid is selected from the group consisting of lutein, astaxanthin, zeaxanthin, bixin, lycopene, β-carotene, and mixtures thereof.

When a carotenoid is present, the composition comprises on a dry matter basis from about 0.1% of said carotenoid to about 90% of said carotenoid, by weight of the composition. The composition comprising on a dry matter basis from about 0.1% of said carotenoid to about 60% of said carotenoid, from about 1% of said carotenoid to about 40% of said carotenoid, from about 1% of said carotenoid to about 30% of said carotenoid, from about 3% of said carotenoid to about 20% of said carotenoid, by weight of the composition.

The vitamin is selected from the group consisting of Vitamin A, Vitamin E, Vitamin C, Vitamin B, CoQ10, thiamine, riboflavin, niacin, folic acid, B12 and mixtures thereof.

When a vitamin is present, the composition comprises on a dry matter basis from about 0.01% of said vitamin to about 90% of said vitamin, by weight of the composition. The composition comprising on a dry matter basis from about 0.1% of said vitamin to about 60% of said vitamin, from about 1% of said vitamin to about 40% of said vitamin, from about 1% of said vitamin to about 30% of said vitamin, from about 3% of said vitamin to about 20% of said vitamin, by weight of the composition.

The mineral is selected from the group consisting of copper, iron, magnesium, manganese, zinc, chromium, cobalt, iodine, selenium, cadmium, and mixtures thereof.

When a mineral is present, the composition comprises on a dry matter basis from about 0.01% of said mineral to about 90% of said mineral, by weight of the composition. The composition comprising on a dry matter basis from about 0.1% of said mineral to about 60% of said mineral, from about 1% of said mineral to about 40% of said mineral, from about 1% of said mineral to about 30% of said mineral, from about 3% of said mineral to about 20% of said mineral, by weight of the composition.

The polyphenol is selected from the group consisting of rosemary, rosemary extract, caffeic acid, coffee extract, tumeric extract, curcumin, blueberry extract, grapeseed extract, rosemarinic acid, tea extract, cocoa, fruit extracts, vegetable extracts, and mixtures thereof.

When a polyphenol is present, the composition comprises on a dry matter basis from about 0.01% of said polyphenol to about 90% of said polyphenol, by weight of the composition. The composition comprising on a dry matter basis from about 0.1% of said polyphenol to about 60% of said polyphenol, from about 1% of said polyphenol to about 40% of said polyphenol, from about 1% of said polyphenol to about 30% of said polyphenol, from about 3% of said polyphenol to about 20% of said polyphenol, by weight of the composition.

The unsaturated fatty acid is selected from the group consisting of omega-3 fatty acids, omega-6 fatty acids, DHA, EPA, and mixtures thereof. The unsaturated fatty acid can be incorporated into the composition as various glycerol esters, including but not limited to triglycerides. When an unsaturated triglyceride is used preferably the unsaturated triglyceride is extracted from flax seed or fish oil.

When an unsaturated fatty acid is present, the composition comprises on a dry matter basis from about 0.01% of said fatty acid to about 90% of said unsaturated fatty acid, by weight of the composition. The composition comprising on a dry matter basis from about 0.1% of said unsaturated fatty acid to about 60% of said unsaturated fatty acid, from about 1% of said unsaturated fatty acid to about 40% of said unsaturated fatty acid, from about 1% of said unsaturated fatty acid to about 30% of said unsaturated fatty acid, from about 3% of said unsaturated fatty acid to about 20% of said unsaturated fatty acid, by weight of the composition.

First Protective Coating

The composition of the present invention comprises a sensitive ingredient which is preferably within a first protective coating. The first protective coating limits the loss in activity of the sensitive ingredient during processing, particularly extrusion, and storage of a composition comprising the sensitive ingredient while maintaining a high degree of bioavailability and chemical stability of the sensitive ingredient throughout the shelf life of the composition and when the composition is ingested. The first protective coating allows for a time release of the sensitive ingredient, a delayed release of the ingredient or a site specific release of the sensitive ingredient. The mechanism for time release or delayed release of the sensitive ingredient is dependent on the type of first protective coating comprised in the composition. Typical but non-limiting mechanisms of time release or delayed release include; dissolution of the coating by immersion in an aqueous mixture, disruption of the coating associated with osmotic pressure, enzymatic dissolution of the coating, and/or acid catalyzed hydrolysis.

The first protective coating can comprise a chitosan matrix, starch matrix, wax matrix, or mixture thereof. The chitosan matrix comprises a chitosan alginate. The multiple positive charges of a chitosan polymer form ionic bonds with the anionic sites of the alginate polymer, thereby forming a durable first protective coating. The first protective coating reduces exposure of the sensitive ingredient to oxygen and free radicals. Typical residual levels for unprotected sensitive ingredients are from 0% to about 50%, from 5% to about 45%, and from about 10 to about 40%, whereas residual levels for protected sensitive ingredients are from about 50% to about 100%, from about 70% to about 95%, and from about 80% to about 90%.

When a first protective coating is present, the composition comprises on a dry matter basis from about 0.01% of said first protective coating to about 95% of said first protective coating, by weight of the composition. The composition comprising on a dry matter basis from about 1% of said first protective coating to about 90% of said first protective coating, from about 10% of said first protective coating to about 80% of said first protective coating, from about 5% of said first protective coating to about 70% of said first protective coating, by weight of the composition.

The first protective coating can additionally comprise colorants, flavorants, aromas, antioxidants, light-reflecting ingredients (such as titanium dioxide), adhesives, and combinations thereof.

Second Protective Coating

The composition of the present invention can comprise a sensitive ingredient that can be within a second protective coating. The second protective coating can be located outside of the first protective coating or located within the first protective coating. The second protective coating comprises either a hydrophilic or hydrophobic coating that provides additional moisture, light, or oxidative protection properties. The second protective coating reduces exposure of the labile material to oxygen, moisture, free radicals, and/or free radical catalysts. Free radical catalysts are typically transition metal ions that are dissolved within the moisture content of the composition itself.

When a secondary protective coating is present, the composition comprises on a dry matter basis from about 0.01% of said secondary protective coating to about 95% of said secondary protective coating, by weight of the composition. The composition comprising on a dry matter basis from about 1% of said secondary protective coating to about 90% of said secondary coating, from about 10% of said secondary protective coating to about 80% of said secondary protective coating, from about 5% of said secondary protective coating to about 70% of said secondary protective coating, by weight of the composition.

The second protective coating can comprise a hydrophobic material. The hydrophobic material is selected from a group consisting of edible waxes, cocoa butter, hydrogenated vegetable oils, hydrogenated fats, and combinations thereof.

The hydrophobic material has a melting point from about 15° C. to about 200° C., preferably from about 20° C. to about 150° C., preferably from about 25° C. to about 125° C., preferably from about 30° C. to about 100° C.

The second protective coating can comprise a hydrophilic material. The hydrophilic material is selected from a group consisting of starches, gums, other vegetable or fruit-based polymers, and combinations thereof.

The second protective coating allows for a time release, delayed release, or site specific release of said sensitive ingredient. The mechanism for time release or delayed release of the sensitive ingredient is dependent on the type of first protective coating comprised in the composition. Typical but non-limiting mechanisms of time release or delayed release include; dissolution of the coating by immersion in an aqueous mixture, disruption of the coating associated with osmotic pressure, enzymatic dissolution of the coating, and/or acid catalyzed hydrolysis.

The second protective coating can additionally comprise colorants, flavorants, aromas, antioxidants, and combinations thereof.

Base Food

The base food is selected from the group consisting of animal protein, plant protein, farinaceous matter, vegetables, fruits, dough, fat, oils, egg-based materials, dairy based products, undenatured proteins, food-grade polymeric adhesives, gels, polyols, starches, gums, binding agents, filler, water, flavorants, starches, seasoning, salts, colorants, time-release compounds, delayed release compounds, specific release compounds, minerals, vitamins, antioxidants, prebiotics, probiotics, aroma modifiers, flavor modifiers, and combinations thereof.

The animal protein may be derived from any of a variety of animal sources including, for example, muscle meat or meat by-product. Nonlimiting examples of animal protein include beef, pork, poultry, lamb, kangaroo, shell fish, crustaceans, fish, and combinations thereof including, for example, muscle meat, meat by-product, meat meal or fish meal.

The plant protein may be derived from any of a variety of plant sources. Nonlimiting examples of plant protein include lupin protein, wheat protein, soy protein, and combinations thereof.

The farinaceous matter may be derived from any of a variety of farinaceous matter sources. Nonlimiting examples of farinaceous matter include grains such as, rice, corn, milo, sorghum, barley, and wheat, and the like, pasta (for example, ground pasta), breading, and combinations thereof.

Vegetables may be derived from any of a variety of vegetable sources. Nonlimiting examples of vegetables include peas, carrots, corn, potatoes, beans, cabbage, tomatoes, celery, broccoli, cauliflower, and leeks.

Fruits may be derived from any of a variety of fruit sources. Nonlimiting examples include tomatoes, apples, avocado, pears, peaches, cherries, apricots, plums, grapes, oranges, grapefruit, lemons, limes, cranberries, raspberries, blueberries, watermelon, cantaloupe, muskmelon, honeydew melon, strawberries, banana, choke cherry, choke berry, currant, and combinations thereof.

Dough may be derived from any of a variety of dough sources. Nonlimiting examples include wheat dough, corn dough, potato dough, soybean dough, rice dough, and combinations thereof.

Fat may be derived from any of a variety of fat sources. Nonlimiting examples include chicken fat, beef fat, pork fat, and combinations thereof.

Oils may be derived from any of a variety of oil sources. Nonlimiting examples include fish oil, corn oil, canola oil, palm oil, canola oil, and combinations thereof. Binding agents may be derived from any of a variety of binding agents. Nonlimiting examples of binders include egg-based materials (including egg whites and preferably dried egg whites), undenatured proteins, food grade polymeric adhesives, gels, polyols, starches (including modified starches), gums, and mixtures thereof.

Nonlimiting examples of polyols include sugar alcohols such as disaccharides and complex carbohydrates. Certain complex carbohydrates are referred commonly as starches. Disaccharides are molecules having the general formula CₙH₂ₙ₋₂Oₙ₋₁, wherein the disaccharide has 2 monosaccharide units connected via a glycosidic bond. In such formula, n is an integer equal to or greater than 3.

Nonlimiting examples of disaccharides which may be utilized herein include sucrose, maltose, lactitol, maltitol, maltulose, and lactose.

Nonlimiting examples of complex carbohydrates include oligosaccharides and polysaccharides. As used herein, the term “oligosaccharide” means a molecule having from 3 to 9 monosaccharide units, wherein the units are covalently connected via glycosidic bonds. As used herein, the term “polysaccharide” means a macromolecule having greater than 9 monosaccharide units, wherein the units are covalently connected via glycosidic bonds. The polysaccharides may be linear chains or branched. Preferably, the polysaccharide has from 9 to about 20 monosaccharide units. Polysaccharides may include starches, which is defined herein to include starches and modified starches. Starches are generally carbohydrate polymers occurring in certain plant species, for example, cereals and tubers, such as corn, wheat, rice, tapioca, potato, pea, and the like. Starches contain linked alpha-D-glucose units. Starches may have either a mainly linear structure (e.g., amylose) or a branched structure (e.g., amylopectin). Starches may be modified by cross-linking to prevent excessive swelling of the starch granules using methods well-known to those skilled in the art. Additional examples of starches include potato starch, corn starch, and the like. Other examples of commercially available starches include ULTRA SPERSE M™, N-LITE LP™, and TEXTRA PLUS™, all available from National Starch and Chemical Company, Bridgewater, N.J.

Nonlimiting examples of preferred complex carbohydrates include raffinose, stachyoses, maltotriose, maltotetraose, glycogen, amylose, amylopectin, polydextrose, and maltodextrin. The filler can be a solid, a liquid or packed air. The filler can be reversible (for example thermo-reversible including gelatin) and/or irreversible (for example thermo-irreversible including egg white). Nonlimiting examples of the filler include gravy, gel, jelly, aspic, sauce, water, gas (for example including nitrogen, carbon dioxide, and atmospheric air), broth, extracts, brine, soup, steam, and combinations thereof.

The filler can optionally further comprise an additional component. Nonlimiting examples of additional components include wheat protein, soy protein, lupin protein, protein flour, textured wheat protein, textured soy protein, textured lupin protein, textured vegetable protein, breading, comminuted meat, flour, comminuted pasta, pasta, water, flavorants, starches, seasoning salts, colorants, time-release compounds, minerals, vitamins, antioxidants, prebiotics, probiotics, aroma modifiers, flavor modifiers, and combinations thereof.

Nonlimiting examples of colorants include, but are not limited to, synthetic or natural colorants, and any combination thereof. A colorant can be malt for brown coloring, titanium dioxide for white coloring, or tomato extract (e.g. lycopene) for red coloring, alalpha (e.g. chlorophyll) for green coloring, algal meal for green coloring, caramel for brown coloring, annatto extract (e.g. bixin, transbixin, and norbixin and combinations thereof) for about yellow-orange color, dehydrated beets for about red-purple coloring, ultramarine blue for about blue-green color, □-carotene for about orange coloring, tagetes (e.g. lutein) for about orange coloring, tumeric for about yellow coloring, tumeric oleoresin for about yellow coloring, saffron for about yellow coloring, corn gluten meal for about yellow coloring, paprika for about red coloring, paprika oleoresin for about orange-red coloring, black iron oxide for about black coloring, brown iron oxide for about brown coloring, red iron oxide for about red coloring, yellow iron oxide for about yellow coloring, red cabbage for about red-purple coloring, carbon black for about black coloring, cochineal extract for about red coloring, carrot oil for about yellow coloring, FD&C Blue No. 1 (Brilliant Blue) for about green-blue coloring, FD&C Blue No. 2 (Indigotine) for about a deep blue coloring, FD&C Green No. 3 (Fast Green) for about blue-green coloring, FD&C Red No. 3 (Erythrosine) for about blue-red coloring, FD&C Red No. 40 (Allura Red) for about yellow-red coloring, FD&C Yellow No. 5 (Tartrazine) for about lemon-yellow coloring, FD&C Yellow No. 6 (Sunset Yellow) for about red-yellow coloring, fruit juice concentrate for inherent coloring (e.g. orange juice concentrate for about orange coloring), grape color extract for red-blue coloring, xanthophylls (e.g. extracted from broccoli) for about green coloring, vegetable juice for inherent coloring (e.g. beet juice for red-purple coloring), riboflavin for about green-yellow coloring, Orange B for about orange coloring, and octopus and squid ink for about black coloring The food composition comprises from about 0.00001% to about 10%, by weight of the product, of said colorant. Preferably food composition comprises from about 0.0001% to about 5%, more preferably from about 0.001% to about 1%, even more preferably from about 0.005% to about 0.1%, by weight of the composition, of said colorant.

### Methods of Stabilizing a Sensitive Ingredient

The sensitive ingredient of the present invention is stabilized by forming a first and/or second protective coating around the sensitive ingredient.

A first embodiment of a stabilizing process includes the steps of; (a) preparing a mixture of an alkali metal alginate by combining water with said alkali metal alginate; (b) adding to said mixture a sensitive ingredient; (c) creating a stream of said mixture comprising the sensitive ingredient; (d) cutting said stream to form a sphere; (e) dropping said sphere into a source of chitosan; and (f) forming a coated sphere within a first protective coating comprising a chitosan alginate. Step (a) can be eliminated if an alkali metal alginate solution is used as the starting material. The ratio of alginate to sensitive ingredient in this embodiment is from about 1:0.5 to about 20:5, from about 1:1 to 20:5, and from about 1:1 to about 6:3, and from about 3:1 to about 6:3.

A second embodiment of a stabilizing process includes the steps of; (a) combining an alkali metal alginate with water; (b) preparing a mixture of said alkali metal alginate with a sensitive ingredient; (c) pumping said mixture to a nozzle; (d) cutting said mixture with a fluid stream; (e) forming a sphere; (f) dropping said sphere into an coating matrix; (g) providing a first protective coating around said sphere; and (h) forming a coated sphere. Step (a) can be eliminated if an alkali metal alginate solution is used as the starting material. The coated spheres can be agitated after they are formed. The ratio of alginate to sensitive ingredient in this embodiment is from about 1:0.5 to about 20:5, f from about 1:1 to 20:5, and from about 1:1 to about 6:3, and from about 3:1 to about 6:3.

The alkali metal alginate is selected from the group consisting of sodium, magnesium, calcium, potassium, ammonium salts, sodium triethanolamine, and combinations thereof.

The cutting of the mixture can be via a fluid stream, spinning cutting wire; or passed through a T and combined with an air stream. The air stream is selected from the group consisting of nitrogen, carbon dioxide, argon, helium, hydrogen, steam, and combinations thereof. The air stream has a Pressure from about 1 psi to about 50 psi, from about 5 psi to about 30 psi, from about 10 psi to about 20 psi. The fluid stream is selected from the group consisting of water, oil, or other food grade solvents.

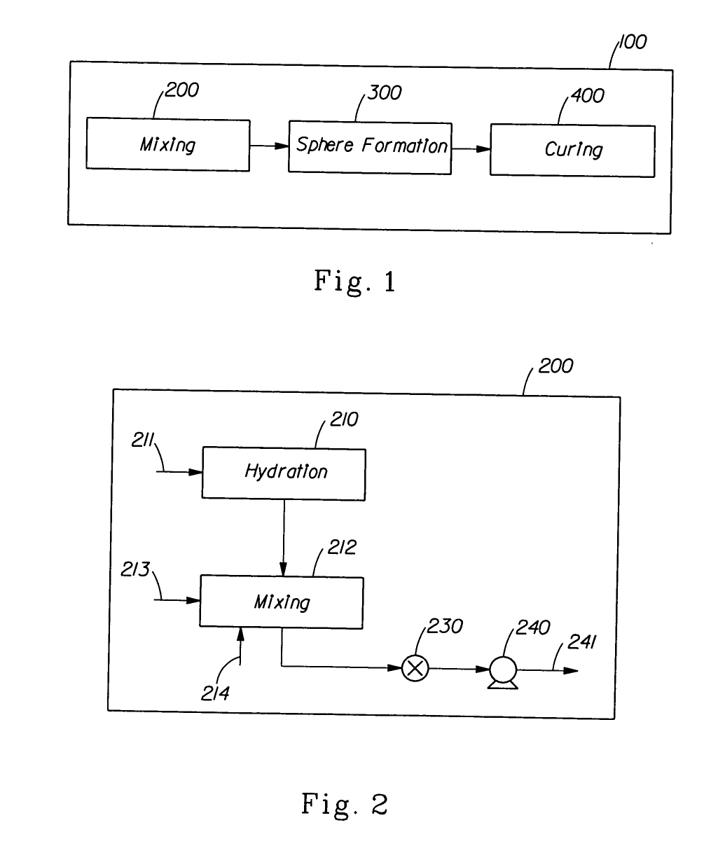

Referring to FIG. 1 is an overall First process 100 comprising at least 3 operations diagramed as block operations. This overall First process 100 is an appropriate process layout for either the first or second embodiments. The 3 operations include an initial block which is a mixing system 200, followed by a sphere formation system 300, and finally a curing system 400.

Referring to FIG. 2 is the mixing system 200. The alginate is mixed with water from an intake line 211 and allowed to hydrate in a mix tank 210. Optionally, heat from about 60° C. to about 80° C. can be applied to 210 for faster hydration. The resulting alkali metal alginate is in form of a viscous mixture having a viscosity from about 40 centipoises (cps) to about 700 centipoises (cps), from about 150 to about 550 centipoises, from about 250 to about 400 centipoises and is transferred via transfer line 212 into a mixing vessel 220 where the sensitive ingredient(s) is added via 213 and mixed to generate a uniform distribution within the mixture. Depending on the end use of the sensitive ingredient within the first and/or second protective coating some additives (e.g. antimicrobial, color, diluent, filler, emulsifier, buffer, antioxidant) can be added directly to the mixing vessel 220 or added via transfer line 214. The resulting mixture from the mixing vessel 220 is transferred using a valve 230 and a positive displacement pump 240 to the sphere formation system via transport line 241.

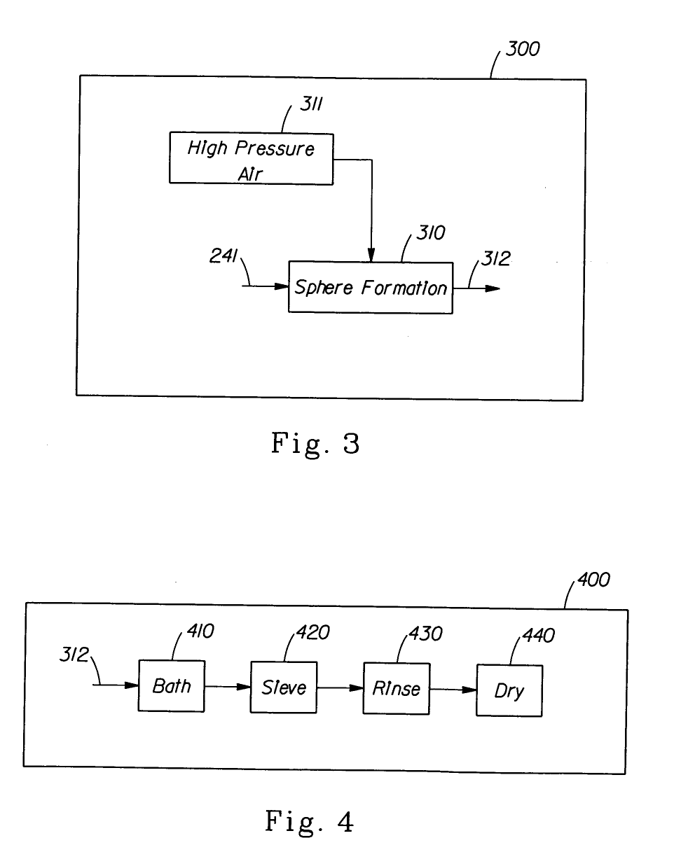

Referring to FIG. 3 is sphere formation system 300. The mixture is transported to sphere formation vessel 310 via transport line 241 at about 0.25 L/min under a psi pressure from about 50 psi to about 90 psi and forming a liquid stream flowing from an opening in the transport line 241. The liquid stream is sprayed through (a) a spinning cutting wire; or (b) water jet cutter that cuts the liquid stream into segments that form spheres. Alternatively, the liquid stream is passed through a connecting T and combined with an air stream 311 under pressure from about 12 psi to about 18 psi prior to the liquid stream exiting an opening in the transport line 241. The air stream 311 forms gaps in the liquid stream flowing from the opening in transport line 241, thereby creating spheres from the liquid stream. The spheres are then transferred by air or mechanically via transfer line 312 to the curing system.

Referring to FIG. 4 is the curing system 400. The formed spheres fall via gravity or are transferred mechanically via transfer line 312 into a bath 410 where the spheres are coated with a cationic crosslinking polymer, preferably chitosan. The coated spheres within a first protective coating comprising a chitosan alginate matrix are removed from the coating bath via a sieve 420 and spray rinsed or submerged in deionized water in a rinse bath 430 before they are dried by using air drying, air oven, fluid bed drier, spray drier, or other drying equipment 440 known in the art.

A third embodiment of a stabilizing process provides for extrusion of the sensitive ingredient and includes the steps of; (a) preparing a mixture of an alkali metal alginate combined with a sensitive ingredient; (b) adding water; (c) forming a dough; (d) placing said dough into an extruder; (e) passing said dough through a die to form a sphere; (f) dropping said sphere into a coating matrix; (g) providing a first protective coating around said sphere; (h) forming a coated sphere. The water can be added before combining the alkali metal alginate with the sensitive ingredient or the water can be added after the alkali metal alginate and the sensitive ingredient is combined. Preferably the ratio of alginate to water to sensitive ingredient is from about 5:95:2 to about 90:10:60, from about 35:75:15 to about 85:15:45, from about 60:40:40 to about 75:25:30. The dough created in (c) is in form of a paste and when diluted to 1% solids solution has a viscosity from about 40 centipoises to about 700 centipoises, from about 150 to about 550 centipoises, from about 250 to about 400 centipoises.

After step (h) forming the coated spheres, the coated spheres can optionally be rinsed, drained and optionally dried.

Referring to FIG. 5 is an overall Second process 500 comprising at least 3 operations diagramed as block operation. This overall Second process 500 is an appropriate process layout for the third embodiment. The 3 operations include an initial block which is a mixing system 600, followed by a sphere formation system 700, and finally a curing system 800.

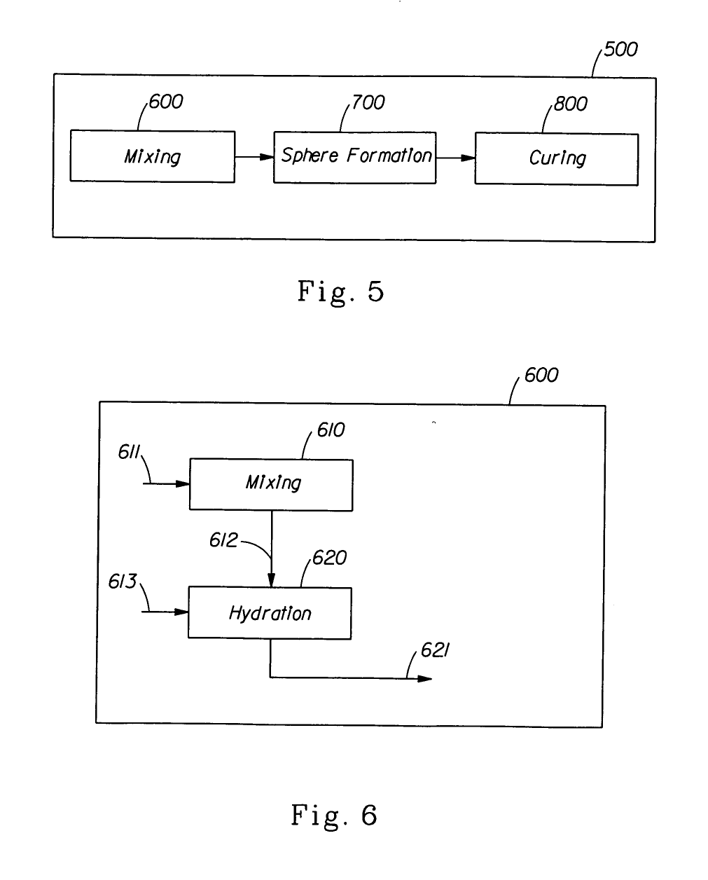

Referring to FIG. 6 is the mixing system 600. The alkali metal alginate is combined with the sensitive ingredient in a mix tank system 610 to form a concentrated mixture. Water is added to the mix tank system via an inlet transfer line 611 to form a dough of said mixture comprising the sensitive ingredient to allow uniform distribution and hydration. Depending on the end use of the formed sphere some additives (e.g. antimicrobial, color, diluent, filler, emulsifier, buffer, antioxidant) can be added at transfer line 612 and/or inlet transfer line 613 and combined and mixed thoroughly with the dough in the conditioning cylinder 620. The resulting dough from 620 is transferred using mechanical conveyor belt 621 to transfer to the sphere formation system.

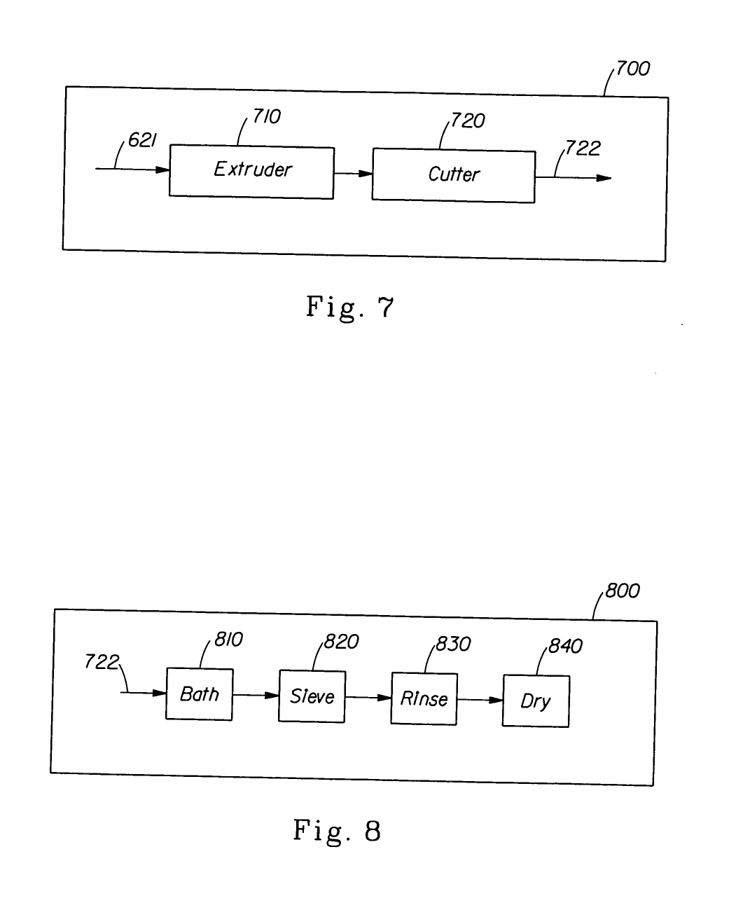

Referring to FIG. 7 is illustrating the sphere formation system 700. The hydrated dough mixture is transported to the extruder 710 via the mechanical conveyor belt 621. The extruder is operated at about 70 psi and 10-12 Hz feed rate. The shaft of the extruder moves the dough to the dye plate with multiple holes from about 1 mm to about 3 mm in size. The size of the holes will depend on the desired size of the sphere. The dough passes through the die and is cut with a knife at a speed from about 20 Hz to about 500 Hz at the die cutting head 720. The formed spheres are transferred from the die cutting head 720 to the curing system via transfer line 722.

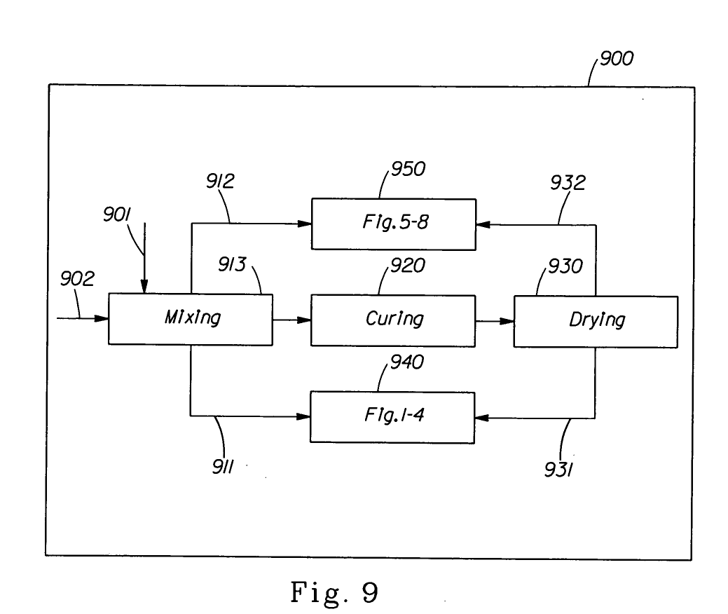

Referring to FIG. 8, the curing system 800 consists of at least 4 operations diagramed as block operations in FIG. 8. The formed spheres fall (gravity fall or mechanical transfer) from transfer line 722 into a bath 810, where the spheres are coated with a cationic crosslinking polymer, preferably chitosan, forming coated spheres within the first protective coating. The coated spheres are separated from the liquid in the bath with a seive 820 and spray rinsed or submerged in deionized water in a rinse tank 830 and are then dried using air drying, air oven, fluid bed drier, spray drier, or other drying equipment 840 known in the art.

A fourth embodiment of a stabilizing process provides for the sensitive ingredient wherein the sensitive ingredient is within a first and second protective coating includes the steps of; (a) preparing a first mixture of a hydrophobic material with a sensitive ingredient; (b) forming a second protective coating with said sensitive ingredient located within said second protective coating; (c) preparing a second mixture by combining an alkali metal alginate with said first mixture; (d) pumping said solution to a nozzle; (e) cutting said solution with a fluid stream; (f) forming a sphere; (g) dropping said sphere into a coating matrix; (h) providing a first protective coating around said sphere; and (i) forming a coated sphere. The second protective coating is formed by combining the sensitive ingredient with a hydrophobic material in a high sheer mixer. The said hydrophobic material is selected from a group consisting of edible waxes, cocoa butter, hydrogenated vegetable oils, hydrogenated fats, and combination thereof.

A fifth embodiment of a stabilizing process provides for extrusion of the sensitive ingredient wherein the sensitive ingredient is within a first and second protective coating includes the steps of; (a) preparing a first mixture of a hydrophobic material with a sensitive ingredient; (b) forming a second protective coating with said sensitive ingredient located within said second protective coating; (c) preparing a second mixture by combining an alkali metal alginate with said first mixture; (d) adding water to said second mixture; (e) creating a dough of said second mixture comprising the sensitive ingredient; (f) extruding said second mixture; (g) forming a sphere of said second mixture; (h) dropping said sphere into a coating matrix, for example a source of chitosan; (i) forming a coated sphere within a first protective coating that can comprise a chitosan alginate.

Referring to FIG. 9, this is a secondary protective coating process 900 consisting of at least one, at least two additional pretreatments step diagramed as block operations. The overall process 900 is an appropriate process layout for the fourth and fifth embodiment of this invention. This secondary protective coating process 900 is an appropriate initial process to provide a second protective coating to a sensitive ingredient prior to or after coating with a first protective coating described using either the overall First or Second processes. The combination of the secondary coating process 900 and either the overall First or Second processes are necessary to provide both of the coatings as described in the fourth and fifth embodiments.

Referring to FIG. 9, a hydrophobic material and sensitive ingredient are added to the mix tank 910 via transfer lines 911 and 912, respectively. The sensitive ingredient and hydrophobic material are uniformly mixed to form a second protective coating. The said second protective coating can be transferred via transport line 911 into the previously described overall First coating process 940 previously detailed in FIGS. 1-4 yielding a complete process appropriate for embodiment 4 or it can be transferred via transport line 912 to the overall Second coating process 950 previously detailed in FIGS. 5-8 yielding a complete process appropriate for embodiment 5. The secondary protective coating can also be transferred via line 913 into curing system 920. The curing system 920 followed by the drying process 930 includes but is not limited to air-oven, fluid bed dryer, spray dries, or other drying equipment known in the art. The resulting product can be transferred via transfer line 931 into the previously described overall First coating process detailed in FIGS. 1-4 yielding a complete process appropriate for embodiment 4, or transferred via transfer line 932 into the previously described overall Second coating process previously detailed in FIGS. 5-8 yielding a complete process appropriate for embodiment 5.

Either the moist, coated spheres or the dried spheres can be added to foods for either pet or human consumption. These spheres can be added as part of a premix prior to the preparation of a food product, coated on the exterior of the food product as a final food preparation step, or added as a topper to the food just prior to consumption by the consumer.

The most common means of adding these spheres to a food is during the preparation of the food product. Typical of the human food compositions which can be prepared are extrusion-expanded ready-to-eat breakfast cereals. Another typical example of pet food compositions which can be prepared are extrusion-expanded dry pet food kibbles. These processes are well-known in the art.

### Compositions

It is anticipated that the sensitive ingredients within a first protective coating and/or second protective coating described in the present invention can be added to any composition adapted for administration to a companion animal, livestock or human.

Nonlimiting examples of dry compositions may optionally contain on a dry matter basis, from about 1% to about 50% crude protein, from about 0.5% to about 25% crude fat, from about 1% to about 10% supplemental fiber, all by weight of the composition. The dry composition may have a total moisture content from about 1% to about 30% moisture. Alternatively, a dry composition may contain on a dry matter basis, from about 5% to about 35% crude protein, from about 5% to about 25% crude fat, from about 2% to about 8% supplemental fiber, all by weight of the composition. The dry composition may have a total moisture content from about 2% to about 20% moisture. Alternatively, the dry composition contains on a dry matter basis, a minimum protein level of about from about 9.5% to about 22%, a minimum fat level of from about 8% to about 13%, a minimum supplemental fiber level of from about 3% to about 7%, all by weight of the composition. The dry animal food composition may also have a minimum metabolizable energy level of about 3.5 Kcal/g. The dry composition may have a total moisture content from about 3% to about 8%,

Nonlimiting examples of a semi-moist composition may optionally contain on a dry matter basis, from about 0.5% to about 50% crude protein, from about 0.5% to about 25% crude fat, from about 0.5% to about 15% supplemental fiber, all by weight of the composition. The semi-moist composition may have a total moisture content from about 30% to about 50% moisture. Alternatively, the semi-moist compositions may contain on a dry matter basis, from about 5% to about 35% crude protein, from about 5% to about 25% crude fat, from about 1% to about 5% supplemental fiber, and all by weight of the composition. The semi-moist composition may have a total moisture content from about 35% to about 45% moisture. Alternatively, the semi-moist composition may have on a dry mater basis, a minimum protein level of about from about 9.5% to about 22%, a minimum fat level of from about 8% to about 13%, a minimum supplemental fiber level of from about 2% to about 3%, all by weight of the composition. The semi-moist composition may have a total moisture content from about 38% to about 42%. The semi-moist composition may also have a minimum metabolizable energy level of about 3.5 Kcal/g and from about 0.1% to about 20% ash, and from about 0.001% to about 5.0% taurine.

Nonlimiting examples of a moist composition may optionally contain on a dry matter basis, from about 5% to about 50% crude protein, from about 0.5% to about 25% crude fat, from about 0.01% to about 15% supplemental fiber, all by weight of the composition. The moist composition may have a total moisture content from about 50% to about 90% moisture. Alternatively, the moist compositions may contain on a dry matter basis, from about 5% to about 35% crude protein, from about 5% to about 25% crude fat, from about 0.05% to about 5% supplemental fiber, all by weight of the composition. The moist composition may have a total moisture content from about 60% to about 85% moisture. Alternatively, a moist animal composition may contain on a dry matter basis, a minimum protein level of about from about 9.5% to about 22%, a minimum fat level of from about 8% to about 13%, a minimum supplemental fiber level of from about 0.1% to about 3%, all by weight of the composition. The moist composition may have a total moisture content from about 65% to about 80%. The moist composition may also have a minimum metabolizable energy level of about 1.0 Kcal/g and from about 0.1% to about 20% ash, and from about 0.001% to about 5.0% taurine.

In one embodiment of the present invention, the composition is a composition, whether dry, moist, semi-moist or otherwise, that comprises on a dry matter basis, from about 5% to about 50%, alternatively 20% to about 50% of animal-derived ingredients, by weight of the composition. Non-limiting examples of animal-derived ingredients include chicken, beef, pork, lamb, turkey (or other animal) protein or fat, egg, fishmeal, and the like.

Where the composition is in the form of a gravy, the composition may comprise at least 10% of a broth, or stock, non-limiting examples of which include vegetable beef, chicken or ham stock. Typical gravy compositions may comprise on a dry matter basis, from about 0.5% to about 5% crude protein, and from about 2% to about 5% crude fat.

Where the composition is in the form of a supplement composition such as biscuits, chews, and other treats, the supplement may comprise, on a dry matter basis, from about 20% to about 60% protein, from about 22% to about 40% protein, by weight of the supplement composition. As another example, the supplement compositions may comprise, on a dry matter basis, from about 5% to about 35% fat, or from about 10% to about 30% fat, by weight of the supplement composition. Compositions and supplement compositions intended for use by animals such as cats or dogs are commonly known in the art.

### Chemical Stability Method

The chemical stability method is an analytical method that measures the amount of sensitive ingredient in the coated sphere or in the food composition. The procedure include the following steps; (a) weighing out samples, (b) transferring the sample to a glass extraction/centrifuge tube, (c) digesting the sample to free the sensitive ingredient from any coating material, (d) extracting the sensitive ingredient into a mixed organic solvent system, (e) hydrolysis of any fats, esters, or cross-linked sensitive ingredients, (f) analyzing the extract via a published HPLC method, and (g) calculating the amount of sensitive material based on a calibration curve associated with a known standard of the sensitive ingredient.

Step (a) involves weighing out either 0.1000 g of encapsulated sensitive ingredient, 0.5000 g of nutrient plus sensitive ingredient premix, or 1.0 gram of finished product and recording weight accurately to 4 decimal places.

Step (b) involves quantitatively transferring the weighed sample into 50-ml glass centrifuge tube which is used for digestion, extraction, and centrifugation.

Step (c) involves, pipetting 2.5 mls of an alginate lyase solution into the glass centrifuge tube containing the sample and mixing thoroughly. To note, the alginate lyase solution is prepared before hand by dissolving approximately 5.5 mg lyase (Sigma, St. Louis, USA) in 100 ml of pH 8.0 tris acetate buffer solution. The buffer solution is also prepared before hand by dissolving 0.6057 g tris acetate in 100 ml water and then adjusting the pH to 8.0 with glacial acetic acid. The centrifuge tube containing the sample and lyase solution mixture is vortexed for 20 seconds and then put into a 40 C water bath for 2 hours to digest.

Step (d) involves adding 7.5 mls of an organic extraction solution (HATE) to the centrifuge tube containing the sample and lyase solution mixture. The organic extraction solution (HATE) is composed of 10 parts Hexane, 7 parts Acetone, 7 parts Toluene, 6 parts Ethyl alcohol. Ten grams of butylated hydroxytoluene (BHT), (Sigma, St. Louis, USA) is added to the mixture in the centrifuge tube if the sensitive ingredient is a carotenoid. If the sensitive ingredient is not a carotenoid, BHT is not added to the mixture. Each centrifuge tube is vortexed for 1 min after the HATE solution has been added.

Step (e) involves hydrolysis of any fats, esters, or cross-linked sensitive ingredients to ensure complete extraction of the sensitive ingredient into the organic extraction solution. Four mls of 40% Methanolic KOH solution is then added to the centrifuge tube and the mixture is vortexed for an additional 1 minute. The centrifuge tubes are then placed in a shaking water bath at 70° C. for 60 minutes. It is important that the liquid level in the centrifuge tube is below the water level of the shaking water bath. After 60 min the samples are removed from the water bath and allowed to cool to room temperature) approximately 30 min. The extraction of the sensitive ingredient into the organic extraction solution is driven to completion by adding 7.5 mls of hexane/ethyl acetate solution (75:25) to the glass centrifuge tube and vortexing the mixture for 1 min. The water and organic extraction solution will separate into two phases, with the top phase or layer being organic and the bottom phase or layer being aqueous. To clarify the two phases, 10 mls of 10% sodium sulfate solution is added to the glass centrifuge tube and the mixture is vortexed for additional 1 min. The glass centrifuge tubes are then placed in a centrifuge and spun for 8 minutes at 1750 rpm, thereby completing the separation between the organic and aqueous layers. A 100 ul aliquot of the organic extraction solution (top layer) is pipetted into a 2 ml amber autosampler vial (National Scientific, Rockwood, Tenn., USA) and diluted to 1 ml by the addition of 900 ul of hexane/ethyl acetate solution (75:25). The hexane ethyl acetate solution is also added via a volumetric pipette.

Step (f) involves chromatographic separation and analysis of the contents of the vial via HPLC. The amber autosampler vial is placed into an autosampler connected to an HPLC (Agilent 1100 series HPLC with PhotoDiode Array detector, Santa Clara, Calif., USA), separated from other constituents using a Phenomenex Luna 5 um Si 150 mm×4.6 mm column (Torrence, Calif., USA). The autosampler on the HPLC is used to inject 100 ul onto the column and is separated using an isocratic separation scheme based on a mobile phase of 65% Hexane, 30% Ethyl Acetate, and 5% Acetone at 1.5 ml/min for 15 minutes. The elution times for common sensitive ingredients are as follows: b-carotene—1.250 minutes, trans lutein—5.490 minutes, 9-cis lutein—7.050 minutes, 13-cis lutein—7.290 minutes, and 15-cis lutein—8.030 minutes. Lambda maximums are used to detect the sensitive ingredients, including 466 nm for b-carotene and 453 nm for Lutein.

Step (g) involves quantiation of the sensitive ingredient in the sample based on a standard calibration curve developed based on a pure sample of the sensitive ingredient. Actual levels in samples are calculated based on the standard calibration curve and reported as mg/kg. The chemical stability of either an uncoated or encapsulated sample is determined by equation 4 as described below;

$$Chemical Stability = \frac{measured level of sensitive ingredient}{added level of sensitive ingredient} . \qquad Equation 4$$

wherein the added level of the sensitive ingredient is the known quantity of sensitive ingredient that was added to the encapsulate, premix sample, or product mix before actual production.

### Bioavailability Method

The bioavailability method is an analytical method that quantitatively measures the amount of sensitive ingredient in plasma and compares it to the amount of sensitive ingredient that was ingested by the human or animal of interest. This analytical method involves the following steps; (a) withdrawing blood from the subject of interest, (b) precipitating the plasma protein, (c) extracting the fatty materials utilizing an organic solvent, (d) removing a portion of the organic solvent and placing it in an autosampler vial, (e) evaporating the organic solvent from the vial using a nitrogen flush, (f) redesolving the residue in methanol containing BHT, (g) injecting the mixture into an HPLC for separation from interferants and quantifying the level of the sensitive ingredient, and (f) calculating the relative bioavailability of the sensitive ingredient relative to a theoretical maximum based on ingestion.

Step (a) involves removing 0.5 ml serum/plasma from the subjective on interest through normal procedures. The plasma is placed in a 5 ml clear reaction vial subsequent sample preparation.

Step (b) involves precipitating the plasma protein in this sample by adding 0.5 ml of reagent grade ethyl alcohol, capping the vial, and vortexing briefly. The precipitation of the proteins in the sample will allow easier separation and extraction of the fatty materials from the plasma in the following steps.

Step (c) involves adding 2 mls of hexane, capping the vial and vortexing for 5 minutes. The vial is then centrifuged at 2400 rpm for 5 minutes at 15 C.

Step (d) involves withdrawing 1.5 mls of the top layer of liquid (the hexane layer) and placing it into an amer glass 2 ml autosampler vial.

Step (e) involves flushing the autosampler vial with nitrogen (minimum flow of 2-5 psi) at 60 C for approximately 5 minutes. All hexane should be evaporated from the vial at this point. If not, the nitrogen flushing step should be repeated.

Step (f) involves adding 0.5 ml of methanol containing 0.1% BHT to the file, and briefly vortexing the vial to redissolve the residue.

Step (g) involves chromatographic separation and analysis of the contents of the vial via HPLC. The procedure, equipment, operating conditions, and elution times are the same as described earlier in Step (f) of the Chemical Stability Method.

Step (h) involves quantitation of the sensitive ingredient in the sample based on a standard calibration curve developed based on a pure sample of the sensitive ingredient that has been ingested by the animal. Actual levels in samples are calculated based on the standard calibration curve and reported as mg/kg. The bioavailability of either an uncoated or encapsulated sample is determined by equation 5 as described below;

$$Bioavailability = \frac{measured level of sensitive ingredient in plasma}{\begin{matrix}Expected level of sensitive \\ ingredient based on ingestion amount\end{matrix}} . \qquad Equation 5$$

wherein the level of the sensitive ingredient ingested is calculated based on the known quantity of sensitive ingredient that was feed to the subject of interest.

### Viscosity Method

The method involves the analysis of the viscosity of the mixtures containing water, alkali metal alginate, and the sensitive ingredients. The viscosity of these materials is important due to its affects on pumping and cutting during processing of the mixture. The steps involved in analyzing samples include; (a) collecting 500 mls of sample, (b) if the sample is a dough (embodiments 3 and 5), diluting sample with water, (c) zeroing viscometer, (d) placing the appropriate test spindle in the mixture at an appropriate level, (e) setting output of the viscometer to read directly in centipose, (f) turning the device on and letting it measure viscosity over a period of time, and (g) recording the output of the viscometer in an appropriate manner.

Step (a) also requires appropriate mixing of the material to ensure uniformity and then collecting 3 individual samples of 500 mls and placing them in 600 ml glass beakers.

Step (b) involves taking a 50 ml aliquot of any dough samples from the extrusion processes (embodiments 3 and 5) and diluting to 500 mls in a 600 ml glass beaker using deionized water. All samples are allowed to equilibrate to room temperature; approximately 21 C before analysis. This requires a maximum sitting time of 30 minutes prior to analysis.

Step (c) involves setting the rpm's to 100 rpm's, turning the viscometer on and letting it run while pressing the autozero button. This procedure calibrates the device.

Step (d) involves placing the appropriate spindle in the device, placing the beaker under the spindle, and lowering the spindle into the mixture to the appropriate height. In the measurements reported in this disclosure, a #2 spindle was used with the following dimensions; spindle diameter 3.16 mm, disk diameter 46.95 mm, thickness 1.61 mm. A Brookfield Viscometer Model DV-II (Middleboro, Mass., USA) was used for all analyses. The spindle is placed into the liquid so that the disk is below the liquid level and the liquid level rises to the registration mark or cleft, about 2.5 cm above the disk on the spindle. One must also take care to make sure no bubbles are trapped on the lower surface of the disk when inserting into the mixture. The remaining steps straightforward as previously detailed.

### Total Moisture Content Method

The method involves the analysis of the total moisture content in the food composition. The analysis is based on the procedure outlined in AOAC method 930.15 and AACC method 44-19.

A food composition sample is prepared by taking one unit volume, for example, 375 gram of the composition, and homogenizing in a food processor to a uniform consistency like a paste. A food composition larger than 375 gram would be subdivided to create equal and representative fractions of the whole such that a 375 gram sample is obtained.

The paste of the food composition is individually sampled in triplicate at a volume less than or equal to 100 ml and placed individually sealed in a 100 ml Nasco Whirl-Pak® (Fort Atkinson, Wis. 53538-0901). During the process of sealing the Whirl-Pak®, excess air is evacuated manually from the container just prior to final closure thereby minimizing the container headspace. The Whirl-Pak® is closed per manufacturer's instructions—tightly folding the bag over three (3) times and bending the tabs over 180 degrees.

All samples are refrigerated at 6° C. for less than 48 h prior to moisture analysis.

For total moisture analysis, the tare weight of each moisture tin and lid are recorded to 0.0001 g. Moisture tins and lids are handled using dry and clean forceps. Moisture tins and lids are held dry over desiccant in a sealed desiccator. A Whirl-Pak® containing a sample is unfolded and a 2.0000+/−0.2000 gram sample is weighed into the uncovered moisture tin. The weight of the sample in the moisture tin is recorded. The lid is placed atop the moisture tin in an open position to allow moisture loss but contain all other material during air oven drying. The lid and moisture tin loaded with sample are placed in an air oven operating at 135° C. for 6 h. Time is tracked using a count-down timer.

After drying, the tin is removed from the oven and the dried lid is placed atop the tin using forceps. The covered moisture tin with dried sample is placed immediately in a desiccator to cool. The sealed desiccator is filled below the stage with active desiccant. Once cool to room temperature, the covered moisture tin with dried sample is weighed to 0.0001 g and weight recorded. The total moisture content of each sample is calculated using the following formula:

Total Moisture Content (%)=100−(weight of tin, lid and sample after drying−empty tin and lid weight)×100/initial sample weight.

### EXAMPLES

The following examples further describe and demonstrate embodiments within the scope of the invention. The examples are given solely for the purpose of illustration and are not to be construed as limitations of the present invention, as many variations thereof are possible without departing from the spirit and scope of the invention. The examples are given on a dry matter basis.

### Examples 1-14 Coated Spheres

| Ingredients | Ex. 1 | Ex. 2 | Ex. 3 | Ex. 4 | Ex. 5 | Ex. 6 | Ex. 7 |
|---|---|---|---|---|---|---|---|
| Alginate | 60% | 50% | 50% | 40% | 50% | 40% | 50% |
| Chitosan | 10% | 10% | 15% | 5% | 18% | 10% | 10% |
| Calcium | 10% | 0% | 0% | 15% | 2% | 0% | 0% |
| Chloride | | | | | | | |
| Wax | 0% | 5% | 0% | 25% | 0% | 0% | 0% |
| Starch | 0% | 0% | 0% | 0% | 0% | 20% | 10% |
| b-Carotene | 20% | 25% | 20% | 1% | 10% | 0% | 0% |
| Lutein | 0% | 5% | 5% | 1% | 10% | 0% | 0% |
| Vitamin A | 0% | 0% | 1% | 3% | 5% | 0% | 0% |
| Vitamin E | 0% | 4% | 5% | 2% | 5% | 0% | 0% |
| Zeaxanthan | 0% | 0% | 1% | 1% | 0% | 0% | 0% |
| Astazanthan | 0% | 0% | 1% | 1% | 0% | 0% | 0% |
| Tocopherols | 0% | 0% | 0% | 1% | 0% | 5% | 5% |
| Vitamin D | 0% | 0% | 0% | 1% | 0% | 5% | 5% |
| Vitamin C | 0% | 0% | 0% | 0% | 0% | 5% | 5% |
| Glucosamine | 0% | 0% | 0% | 0% | 0% | 15% | 13% |
| Colorant | 0% | 15% | 2% | 1% | 0% | 0% | 0% |
| Flavorant | 0% | 0% | 0% | 3% | 0% | 0% | 2% |
| | | | | | | | Ex. |
| Ingredients | Ex. 8 | Ex. 9 | Ex. 10 | Ex. 11 | Ex. 12 | Ex. 13 | 14 |
| Alginate | 75% | 70% | 70% | 30% | 40% | 25% | 25% |
| Chitosan | 0% | 5% | 0% | 15% | 18% | 10% | 0% |
| Calcium | 10% | 2% | 3% | 5% | 2% | 0% | 5% |
| Chloride | | | | | | | |
| Wax | 0% | 5% | 0% | 15% | 0% | 0% | 0% |
| Starch | 0% | 0% | 0% | 0% | 0% | 20% | 10% |
| b-Carotene | 15% | 0% | 7% | 5% | 10% | 0% | 0% |
| Lutein | 0% | 0% | 10% | 5% | 10% | 0% | 25% |
| Vitamin A | 0% | 0% | 1% | 5% | 5% | 10% | 10% |
| Vitamin E | 0% | 0% | 4% | 5% | 5% | 0% | 0% |
| Zeaxanthan | 0% | 0% | 1% | 5% | 0% | 0% | 0% |
| Astazanthan | 0% | 17% | 2% | 5% | 5% | 0% | 0% |
| Tocopherols | 0% | 0% | 1% | 5% | 5% | 5% | 5% |
| Vitamin D | 0% | 0% | 0% | 0% | 0% | 5% | 5% |
| Vitamin C | 0% | 0% | 0% | 0% | 0% | 5% | 5% |
| Glucosamine | 0% | 0% | 0% | 0% | 0% | 20% | 5% |
| Colorant | 0% | 1% | 1% | 0% | 0% | 0% | 0% |
| Flavorant | 0% | 0% | 0% | 0% | 0% | 0% | 5% |

The coated spheres of Examples 1-14 can include various levels of alginate or chitosan, or calcium chloride, or wax, or starch, or mixture thereof. The spheres can include dry or liquid, or mixture thereof of B-carotene, or lutein, or Vitamin A, or Vitamin E, or Zeaxanthin, or Astaxanthin, or tocopherols, or Vitamin D, or Vitamin C, or Glucosamine, or colorant, or flavorant, or mixture thereof. The dry composition of Examples 1-14 can be made by first hydrating sodium alginate with water and adding to it a sensitive ingredient, such as B-carotene, or lutein, or Vitamin A, or Vitamin E, or Zeaxanthin, or Astaxanthin, or Vitamin D, or glucosamine, or a fatty acid, or mixtures of these. The mixture is pumped through a pneumatic nozzle where the stream is being cut with a pressurized air into spheres. The spheres drop into a chitosan containing bath forming a first protective coating. The coated spheres are drained, washed with water and dried in a fluid bath drier The dried coated spheres can then be incorporated into the dry composition, moist composition, wet composition, and gravies.

### Examples 15-20

| Ingredients | Ex. 15 | Ex. 16 | Ex. 17 | Ex. 18 | Ex. 19 | Ex. 20 |
|---|---|---|---|---|---|---|
| Active | .1% | .3% | .5% | 1.0% | .5% | .25% |
| ingredient | | | | | | |
| sphere or bead | | | | | | |
| Poultry or | 29% | 42% | 44% | 47% | 0% | 0% |
| Poultry by- | | | | | | |
| products | | | | | | |
| Fish Meal | 15% | 5% | 0% | 0% | 0% | 0% |
| Chicken Fat | 0% | 0% | 6% | 8% | 3.0% | 3.0% |
| Animal Fat | 8% | 6% | 0% | 0% | 0% | 0% |
| Beef particles | 0% | 0% | 0% | 0% | 3.0% | 0% |
| and broth | | | | | | |
| Chicken | 0% | 0% | 0% | 0% | 0% | 3% |
| particles and | | | | | | |
| broth | | | | | | |
| Beet pulp | 2% | 3% | 1.5% | 1% | .4% | .4% |
| Xanthan gum | 0% | 0% | 0% | 0% | .5% | .5% |
| Flax seed | 0% | 0% | 0% | 0% | .2% | .15% |
| Vegetables | 0% | 0% | 0% | 0% | .2% | .2% |
| Vitamins and | 1% | 1% | 1% | 1% | .1% | .1% |
| minerals | | | | | | |
| Salts | 2.5% | 2% | 2.5% | 2% | 0% | 0% |
| Phosphoric | 0% | 0% | 0% | 0% | .95% | .95% |
| Acid | | | | | | |
| Minors | 3.5% | 4.0% | 3.5% | 4.0% | 0% | 0% |
| Chicken | 0% | 0% | 0% | 0% | 0% | .53% |
| Flavor | | | | | | |
| Grains | Q.S. | Q.S. | Q.S. | Q.S. | 0% | 0% |
| (corn, | | | | | | |
| sorghum, | | | | | | |
| barley, rice) | | | | | | |
| Water | 0% | 0% | 0% | 0% | Q.S. | Q.S. |
| Short-chain | .15% | .19% | .15% | .19% | 5.3% | 0% |
| oligo- | | | | | | |
| saccharides | | | | | | |

The dry compositions of Examples 15, 16, 17, and 18 can be made by first, milling and mixing the cereal grains with vitamins and minerals and fiber sources and the coated spheres Then, add the cereal grains to the meat products and other protein sources. Extrude the ingredients into kibbles. Dry the kibbles. Package the finished product.

Examples 19 and 20 are of beef and chicken flavored gravies. The gravies can be made by first, combining the coated sphere with chicken fat and broth. Then, add beet pulp, xanthan gum, flax seed, vegetables, minerals and vitamins to the liquid mixture. Package in bottles as hot fill.

### Examples 21-28

| | Moist compositions | | | | | | | |
|---|---|---|---|---|---|---|---|---|
| | Examples: | | | | | | | |
| | | | | | | Ex. | Ex. | Ex. |
| | Ex. 21 | Ex. 22 | Ex. 23 | Ex. 24 | Ex. 25 | 26 | 27 | 28 |
| Active ingredient | .10% | .20% | .1% | .3% | .5% | .25% | .2% | .15% |
| sphere or bead | | | | | | | | |
| Water | 6.18% | 3.12% | 14.55% | 5.95% | 5.78% | | | |
| Chicken, | 53.95% | 28.53% | 66.93% | 53.68% | 53.9% | | | |
| comminuted | | | | | | | | |
| Wet Textured | | 32.57% | | | | | | |
| Wheat Protein | | | | | | | | |
| (Water, Wheat | | | | | | | | |
| Gluten, Wheat | | | | | | | | |
| Flour, Caramel, | | | | | | | | |
| Phosphate, | | | | | | | | |
| Antioxidants) | | | | | | | | |
| Beef | 23.49% | 12.42% | | | | | | |
| Salmon | | | | 23.38% | | | | |
| Kangaroo | | | | | 23.5% | | | |
| Carrots, 6.4 mm | | 6.86% | | | | | | |
| cube | | | | | | | | |
| Peas | | 4.52% | | | | | | |
| Dehydrated Potato | | 3.18% | | | | | | |
| 9.5 mm cube | | | | | | | | |
| Animal Plasma | 4.28% | 2.26% | 4.68% | 4.26% | 4.27% | | | |
| APC, Inc. Ames, | | | | | | | | |
| IA | | | | | | | | |
| Beet Pulp | 3.523% | 1.863% | 3.648% | 3.506% | 3.52% | | | |
| Calcium Carbonate | 1.60% | 0.846% | 1.67% | 1.59% | 1.60% | | | |
| Sodium | 1.25% | 0.66% | 1.37% | 1.24% | 1.25% | | | |
| Tripolyphosphate | | | | | | | | |
| Astaris, St. Louis, | | | | | | | | |
| Mo | | | | | | | | |
| L-Lysine | 0.811% | 0.429% | 1.040% | 0.807% | 0.81% | | | |
| Potassium Chloride | 0.806% | 0.426% | 0.881% | 0.802% | 0.81% | | | |
| Choline Chloride | 0.528% | 0.279% | 0.516% | 0.525% | 0.53% | | | |
| Vitamins | 0.487% | 0.257% | 0.504% | 0.485% | 0.49% | | | |
| Onion Powder | 0.374% | 0.198% | 0.394% | 0.373% | 0.37% | | | |
| Trace Minerals | 0.371% | 0.196% | 0.375% | 0.370% | 0.37% | | | |
| Salt | 0.362% | 0.191% | 0.375% | 0.360% | 0.36% | | | |
| Fish Oil | 1.005% | 0.532% | 1.256% | 1.000% | 1.01% | | | |
| DL-Methionine | 0.096% | 0.051% | 0.162% | 0.096% | 0.10% | | | |
| Garlic Powder | 0.125% | 0.066% | 0.197% | 0.125% | 0.13% | | | |
| Mixed Tocopherols | 0.071% | 0.037% | 0.070% | 0.070% | 0.07% | | | |
| Iron Chelate 20% | 0.061% | 0.032% | 0.069% | 0.060% | 0.06% | | | |
| Albion, UT | | | | | | | | |
| Celery Powder | | | 0.134% | | | | | |
| Dried Cod | | | | | | 99.75% | | |
| Beef Jerky | | | | | | | 99.80% | |
| Broiled Duck | | | | | | | | 99.85% |
| Breast | | | | | | | | |
| Colorant | | | | | | | | |
| FD&C Yellow 5 | | | | 0.83% | | | | |
| FD&C Red 40 | | | | 0.17% | 0.08% | | | |
| Titanium dioxide | | | 1.05% | | | | | |
| powder | | | | | | | | |
| Malt | 0.50% | 0.27% | | | 0.50% | | | |

The Examples 21-28 are of moist composition. The moist composition can be made by first, combining the coated sphere with meat or wet texture wheat protein. Then, add the water, vegetable powders, beet pulp, vitamins, minerals, oil. The composition can be extruded or baked, and placed into package. The coated spheres described in Examples 1-14 can be incorporated into each of examples 15-28.

### Examples 29-34

| | | Ex. | Ex. | Ex. | Ex. | Ex. |
|---|---|---|---|---|---|---|
| | Ex. 29 | 30 | 31 | 32 | 33 | 34 |
| Alginate | 60% | 46.2% | 46.2% | 46.2% | 33.3% | 35.3% |
| b-Carotene | 0% | 23.1% | 0% | 0% | 0% | 0% |
| Lutein | 0% | 0% | 23.1% | 0% | 0% | 0% |
| Vitamin E | 0% | 0% | 0% | 23.1% | 16.7% | 17.6% |
| Water | 40% | 30.8% | 30.8% | 30.8% | 50.0% | 47.1% |
| Viscosity | 124 | 88.8 | 96.0 | 99.2 | 71.2 | 72.8 |
| | cps | cps | cps | cps | cps | cps |

Examples 29-34 are moist examples of coated spheres. The Examples can be made by first combining the dry sodium alginate with deionized water and adding to it a sensitive ingredient, such as B-carotene, or lutein, or Vitamin E, or mixtures and then viscosity can be measured by the viscosity method described herein.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of forming an coated sphere comprising the steps:
(a) combining an alkali metal alginate with water;
(b) preparing a mixture of said alkali metal alginate with a sensitive ingredient;
(c) pumping said mixture to a nozzle;
(d) cutting said mixture with a fluid stream;
(e) forming a sphere;
(f) dropping said sphere into an coating matrix;
(g) providing a first protective coating around said sphere; and
(h) forming a coated sphere.

2. The process of claim 1, further comprising agitating said coated sphere.

3. The process of claim 1, wherein said mixture has a viscosity from about 40 cps to about 700 cps.

4. The process of claim 1, wherein said mixture has a viscosity from about 150 cps to about 550 cps.

5. The process of claim 1, wherein said mixture has a viscosity from about 250 cps to about 400 cps.

6. The process of claim 1, wherein said fluid stream is selected from the group consisting of air, nitrogen, carbon dioxide, argon, water, helium, oxygen, ethanol, food grade organic solvents, and combinations thereof.

7. The process of claim 6, wherein said fluid stream is air.

8. The process of claim 7, wherein said air stream has a Pressure from about 1 psi to about 50 psi.

9. The process of claim 7, wherein said air stream has a Pressure from about 5 psi to about 30 psi.

10. The process of claim 7, wherein said air stream has a Pressure from about 10 psi to about 20 psi.

11. The process of claim 1, wherein the ratio of alginate to sensitive ingredient is from about 1:0.5 to about 20:5.

12. The process of claim 1, wherein the ratio of alginate to sensitive ingredient is from about 1:1 to about 20:5.

13. The process of claim 1, wherein said sensitive ingredient comprises at least one carotenoid, polyphenol, vitamin, mineral, unsaturated fatty acid, unsaturated triglyceride, antioxidant, amino acid, enzyme, prebiotic, or probiotic.

14. The process of claim 13, wherein said carotenoid is selected from the group consisting of lutein, astaxanthin, zeaxanthin, bixin, lycopene, 3-carotene, and mixtures thereof.

15. The process of claim 13, wherein said carotenoid is present from about 0.01% to about 90%, by weight of the composition.

16. The process of claim 13, wherein said vitamin is selected from the group consisting of Vitamin A, Vitamin E, Vitamin C, Vitamin B, CoQ10, thiamine, riboflavin, niacin, folic acid, B12 and mixtures thereof.

17. The process of claim 13, wherein said vitamin is present from about 0.01% to about 90%, by weight of the composition.

18. The process of claim 13, wherein said mineral is selected from the group consisting of copper, iron, magnesium, manganese, zinc, chromium, cobalt, iodine, selenium, and mixtures thereof.

19. The process of claim 13, wherein said mineral is present from about 0.01% to about 90%, by weight of the composition.

20. The process of claim 13, wherein said polyphenol is selected from the group consisting of rosemary, rosemary extract, caffeic acid, coffee extract, tumeric extract, curcumin, blueberry extract, grapeseed extract, rosemarinic acid, tea extract, chocolate, fruit extracts, vegetable extracts, and mixtures thereof.

21. The process of claim 13, wherein said polyphenol is present from about 0.01% to about 90%, by weight of the composition.

22. The process of claim 13, wherein said unsaturated fatty acid is selected from the group consisting of omega-3 fatty acids, omega-6 fatty acids, DHA, EPA, and mixtures thereof.

23. The process of claim 13, wherein said unsaturated fatty acid is present from about 0.01% to about 90%, by weight of the composition.

24. The process of claim 1, wherein said coating matrix is selected from the group consisting of chitosan alginate, calcium alginate, and mixtures thereof.

25. The process of claim 1, wherein said first protective coating comprises a colorant.

26. The process of claim 1, wherein said first protective coating comprises a flavorant.

27. The process of claim 1, wherein the said first protective coating allows for a time release, delayed release, or site specific release of said sensitive ingredient.

28. The process of claim 1, wherein said coated sphere is combined with a base food to form a food composition.

29. The process of claim 28, wherein said food composition is selected from the group consisting of pet food, dog food, cat food, treats, chew, biscuits, gravy, sauce, beverage, supplemental water, and combinations thereof.

30. The process of claim 29, wherein said food composition is wet or dry.

31. The process of claim 1, wherein said sphere is further within a second protective coating.

32. The process of claim 31, wherein the said second protective coating comprises a hydrophobic material.

33. The process of claim 32, wherein said hydrophobic material is selected from a group consisting of edible waxes, cocoa butter, hydrogenated vegetable oils, hydrogenated fats, and combinations thereof.

34. The process of claim 32, wherein said hydrophobic material has a melting point from about 15° C. to about 200° C.

35. A coated sphere prepared by a process comprising the steps:
(a) combining an alkali metal alginate with water;
(b) preparing a mixture of said alkali metal alginate with a sensitive ingredient;
(c) pumping said mixture to a nozzle;
(d) cutting said mixture with a fluid stream;
(e) forming a sphere;
(f) dropping said sphere into a coating matrix;
(g) providing a first protective coating around said sphere; and
(h) forming a coated sphere.

36. The composition of claim 35, wherein said mixture has a viscosity from about 50 cps to about 700 cps.

37. The process of claim 35, wherein said fluid stream is selected from the group consisting of air, nitrogen, carbon dioxide, argon, water, helium, oxygen, ethanol, food grade organic solvents, and combinations thereof.

38. The process of claim 37, wherein said fluid stream is air.

39. The process of claim 38, wherein said air stream has a Pressure from about 1 psi to about 50 psi.

40. The composition of claim 35, wherein the ratio of alginate to sensitive ingredient is from about 1:0.5 to about 20:5.

41. The composition of claim 35, wherein said sensitive ingredient comprises at least one carotenoid, polyphenol, vitamin, mineral, unsaturated fatty acid, unsaturated triglycerides, antioxidant, amino acid, enzyme, prebiotic, or probiotic.

42. A process of forming an coated sphere comprising the steps:
(a) preparing a first mixture of a hydrophobic material with a sensitive ingredient;
(b) forming a second protective coating with said sensitive ingredient located within said second protective coating;
(c) combining an alkali metal alginate with water;
(d) preparing a second mixture by combining said alkali metal alginate with said first mixture;
(e) pumping said second mixture to a nozzle;
(f) cutting said second mixture with a fluid stream;
(g) forming a sphere;
(h) dropping said sphere into a coating matrix;
(i) providing a first protective coating around said sphere; and
(j) forming a coated sphere.
